(19) United States
(12) Patent Application Publication
(10) Pub. No.: US 2026/0061671 A1
(43) Pub. Date: Mar. 5, 2026

(54) COMFORT eTPU

(71) Applicant: BASF SE, Ludwigshafen am Rhein (DE)

(72) Inventors: Frank Prissok, Lemfoerde (DE); Elmar Poeselt, Lemfoerde (DE); Lisa Marie Schmidt, Lemfoerde (DE); Theresa Huelsmann, Lemfoerde (DE); Frank Thielbeer, Lemfoerde (DE); Peter Gutmann, Ludwigshafen am Rhein (DE); Uwe Keppeler, Ludwigshafen am Rhein (DE)

(73) Assignee: BASF SE, Ludwigshafen am Rhein (DE)

(21) Appl. No.: 19/382,715

(22) Filed: Nov. 7, 2025

Related U.S. Application Data
(62) Division of application No. 17/755,917.

(30) Foreign Application Priority Data
Nov. 13, 2019 (EP) 19208917.5

(51) Int. Cl. B29C 44/34; B29C 44/04; B29K 75/00; B29K 105/04; C08J 9/16

(52) U.S. Cl. CPC B29C 44/355; B29C 44/04; C08J 9/16; B29K 2075/00; B29K 2105/048; B29K 2995/0063; B29K 2995/0078; C08J 2300/22; C08J 2300/26; C08J 2375/04

(57) ABSTRACT

Molded articles contain a foam composed of a thermoplastic elastomer (TPE-1). The foam has a storage modulus (G modulus) at 25° C. and 1 Hz within the range from 0.01 to 0.5 MPa, a molding density within the range from 20 to 400 kg/m³, and a comfort factor of greater than 4. A process produces molded articles of this kind, and the molded article can be used for producing floors, mattresses, seating furniture, bicycle saddles, car seats, motorcycle seats, components of a shoe, shoe inserts, packaging, shock absorbers, protectors, fall protection mats, elastic insulating material, or sealing material.

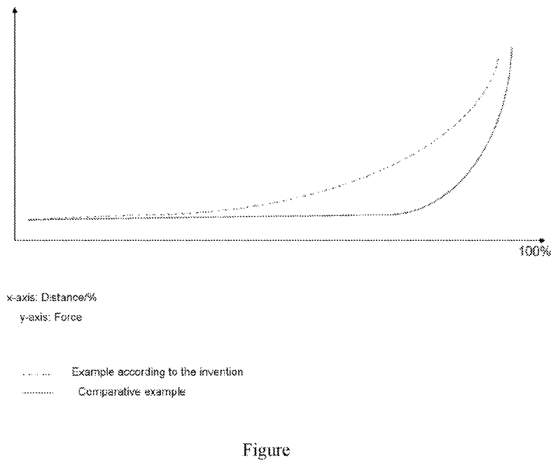

### CROSS REFERENCE TO RELATED APPLICATIONS

This application is a divisional of U.S. application Ser. No. 17/755,917, filed on May 11, 2022, which is the National Stage entry under § 371 of International Patent Application No. PCT/EP2020/082052, filed on Nov. 13, 2020, and which claims benefit of European Patent Application No. 19208917.5, filed on Nov. 13, 2019, the content of each of which is hereby incorporated by reference in its entirety.

### BACKGROUND OF THE INVENTION

### Field of the Invention

The present invention relates to molded articles comprising a foam composed of a thermoplastic elastomer (TPE-1), wherein the foam has a storage modulus (G modulus) at 25° C. and 1 Hz within the range from 0.01 to 0.5 MPa, a molding density within the range from 20 to 400 kg/m³, and a comfort factor, i.e. a compression hardness ratio (StH65%/StH25%), determined in accordance with Reference Example 3, of greater than 4. The present invention further relates to a process for producing molded articles of this kind and to the use of a molded article of the invention for producing floors, mattresses, seating furniture, a bicycle saddle, car seats, motorcycle seats, components of a shoe, as shoe inserts, packaging, shock absorbers, protectors, fall protection mats, elastic insulating material, or sealing material.

### Description of Related Art

Foams, including in particular bead foams, have long been known and have been described many times in the literature, for example in Ullmann's “Encyklopädie der technischen Chemie” [Encyclopedia of Industrial Chemistry], 4th edition, volume 20, pp. 416 ff.

Highly elastic, largely closed-cell foams, such as bead foams composed of thermoplastic elastomers, that are produced for example in an autoclave or by the extruder method, exhibit special dynamic properties and in some cases good resilience too. Hybrid foams composed of beads of thermoplastic elastomers and system foam or binders are also known. Depending on the foam density, the manner of production, and the matrix material, it is possible to produce a relatively broad range of stiffness levels overall. Post-treatment of the foam, such as heat treatment, can also influence the properties of the foam.

Foamed pellet materials, which are also referred to as bead foams (or particle foams), and also molded articles produced therefrom, based on thermoplastic polyurethane or other elastomers, are known (e.g. WO 94/20568, WO 2007/082838 A1, WO2017/030835, WO 2013/153190 A1, WO2010/010010) and have manifold possible uses.

For the purposes of the present invention, a “foamed pellet material” or else a “bead foam” or “particle foam” refers to a foam in bead form, in which the average diameter of the beads is from 0.2 to 20 mm, preferably 0.5 to 15 mm, and in particular between 1 to 12 mm. In the case of non-spherical, e.g. elongate or cylindrical beads, diameter means the longest dimension.

Polymers based on thermoplastic elastomers (TPE) are already used in various fields. The properties of the polymer may be modified according to use. Thermoplastic polyurethanes in particular are used in a variety of ways.

For uses in upholstery, good damping is necessary in order to ensure a high level of seating comfort. However, when sitting on soft seat materials, very strong compression of the material frequently occurs and, beyond a relatively high level of compression, the material, which is usually an open-cell PU foam, suddenly hardens, as a result of which the material becomes uncomfortably hard for the user.

### SUMMARY OF THE INVENTION

It was therefore an object of the present invention to provide molded articles based on thermoplastic elastomers that have good damping and adjustable rebound properties and at the same time offer a high level of seating comfort. Materials that are particularly suitable are those in which stiffening increases slowly with increasing compression, in order to provide more stability when sitting. A further object of the present invention was to provide a process for producing the corresponding molded articles.

### BRIEF DESCRIPTION OF THE DRAWINGS

The FIGURE shows a diagram comparing the stress-strain curves of an example according to the invention with that of a comparative example. The force (y-axis) is here plotted against the distance (%, x-axis).

### DETAILED DESCRIPTION OF THE INVENTION

This object is achieved in accordance with the invention by molded articles comprising a foam composed of a thermoplastic elastomer (TPE-1), wherein the foam has a storage modulus (G modulus) at 25° C. and 1 Hz within the range from 0.01 to 0.5 MPa, determined in accordance with Reference Example 1 (TPE molding), and a molding density within the range from 20 to 400 kg/m³, determined in accordance with Reference Example 2, wherein the foam is a foamed pellet material.

The invention relates also to molded articles comprising a foam composed of a thermoplastic elastomer (TPE-1), wherein the foam has a storage modulus (G modulus) at 25° C. and 1 Hz within the range from 0.01 to 0.5 MPa, determined in accordance with Reference Example 1 (TPE molding), and a molding density within the range from 20 to 400 kg/m³, determined in accordance with Reference Example 2, wherein the foam has a comfort factor of greater than 4, determined in accordance with Reference Example 3.

When the foam is present in the molded article in the form of non-connected beads, the molding density determined in accordance with through Reference Example 2 corresponds in the context of the present invention to the bulk density determined through Reference Example 4 or a value greater than this.

It was surprisingly found that, when using largely closed-cell foams based on thermoplastic elastomers, in particular foamed pellets, having a low storage modulus and a molding density within the range from 20 to 400 kg/m³, it was possible to achieve a foam having low stiffness that does not suddenly compress when sitting, but stiffens steadily depending on the degree of compression. Through the use in accordance with the invention of a foamed pellet material having the defined properties, i.e. a storage modulus (G modulus) at 25° C. and 1 Hz within the range from 0.01 to 0.5 MPa, determined in accordance with Reference Example 1 (TPE molding) and a molding density within the range from 20 to 400 kg/m³, determined in accordance with Reference Example 2, molded articles are obtained that have for example particularly favorable combinations of properties for seating furniture. It was thus found that just a comfort factor of greater than 4, determined in accordance with Reference Example 3, has a significant influence on comfort when sitting. Through the combination according to the invention of the properties of the employed foam, it is possible to obtain a molded article that has a comfort factor of greater than 4, determined in accordance with Reference Example 3. The compression behavior of the molded article resembles initially that of an open-cell flexible foam and later a closed-cell bead foam; hardening does not take effect suddenly, as is the case with open-cell flexible foam, instead there is a continuous rise in backpressure, which slows the user down.

Surprisingly, it is not just the G modulus of the thermoplastic elastomer that is critical for the initial stiffness, but also the G modulus of the foam and the density of the foam. A regular foam structure is moreover advantageous, since this undergoes even compression and consequently seems softer to begin with.

Thus, for example, the diagram shown in the FIGURE, which compares the stress-strain curves of an example according to the invention with a comparative example, shows that the initial phase is flat to begin with and gradually rises.

The molded article of the invention comprises a foam composed of a thermoplastic elastomer (TPE-1), said foam having a storage modulus (G modulus) at 25° C. and 1 Hz within the range from 0.01 to 0.5 MPa, determined in accordance with Reference Example 1 (TPE molding), and a molding density within the range from 20 to 400 kg/m³, determined in accordance with Reference Example 2, and also preferably a comfort factor of greater than 4, determined in accordance with Reference Example 3. In accordance with the invention, the foam may in the context of the present invention be a slabstock foam or else consist of or comprise a foamed pellet material. According to the invention, it is possible here for the molded article to comprise the beads of the foamed pellet material in the form of the individual beads or in fused form, for example in the form of welded or adhesively bonded beads of the foamed pellet material.

According to the invention, it is also possible for the beads of the foamed pellet material to be surrounded by a matrix, i.e. embedded for example in a foam or a compact polymer. A foam that is a foamed pellet material is understood in the context of the present invention to mean embodiments in which the foam consists of or comprises a foamed pellet material. According to the invention, a foam that is a foamed pellet material may also be a foamed pellet material surrounded by a matrix.

According to the invention, the foam preferably has a comfort factor of greater than 4, determined in accordance with Reference Example 3, preferably a comfort factor within the range from 4 to 12, for example within a range from 5 to 11 or else within a range from 5 to 10, in each case determined in accordance with Reference Example 3.

Processes for producing foamed pellets from thermoplastic elastomers are known per se to those skilled in the art. When a foamed pellet material composed of the thermoplastic elastomer (TPE-1) is used in accordance with the invention, the bulk density of the foamed pellet material is for example within the range from 20 g/l to 250 g/l, preferably 50 g/l to 180 g/l, more preferably 60 g/l to 150 g/l.

For example, the diameter of the foamed pellets is between 0.2 to 20 mm, preferably 1 to 15 mm, and in particular between 3 to 12 mm. In the case of non-spherical, for example elongate or cylindrical foamed pellets, diameter means the longest dimension.

In one embodiment, the present invention relates also to a molded article as described hereinabove, wherein the foam is a foamed pellet material.

Suitable thermoplastic elastomers for producing the foams or molded articles of the invention are known per se to those skilled in the art. Suitable thermoplastic elastomers are described for example in “Handbook of Thermoplastic Elastomers”, 2nd edition, June 2014. For example, the thermoplastic elastomer (TPE-1) may be a thermoplastic polyurethane, a thermoplastic polyetheramide, a polyetherester, a polyesterester, a thermoplastic olefin-based elastomer, a crosslinked thermoplastic olefin-based elastomer, or a thermoplastic vulcanizate or a thermoplastic styrene-butadiene block copolymer. According to the invention, the thermoplastic elastomer (TPE-1) may preferably be a thermoplastic polyurethane, a thermoplastic polyetheramide, a polyetherester, a polyesterester or a thermoplastic styrene-butadiene block copolymer.

The thermoplastic elastomer (TPE-1) is in the context of the present invention further preferably a thermoplastic polyurethane, a thermoplastic polyetheramide or a polyesterester or polyetherester.

In a further embodiment, the present invention accordingly relates also to a molded article as described hereinabove, wherein the thermoplastic elastomer (TPE-1) is selected from the group consisting of thermoplastic polyurethanes, thermoplastic polyetheramides, polyetheresters, polyesteresters, thermoplastic olefin-based elastomers, crosslinked thermoplastic olefin-based elastomers, thermoplastic vulcanizates or thermoplastic styrene-butadiene block copolymers, selected in particular from thermoplastic polyurethanes, thermoplastic polyetheramides, polyetheresters, polyesteresters, or thermoplastic styrene-butadiene block copolymers.

Suitable thermoplastic elastomers are in particular those that in the compact state have a G modulus within the range from 0.8 to 8.5 MPa, determined in accordance with Reference Example 6. In a further embodiment, the present invention accordingly also relates to a molded article as described hereinabove, wherein the thermoplastic elastomer (TPE-1) in the compact state has a G modulus within the range from 0.8 to 8.5 MPa, determined in accordance with Reference Example 6.

Suitable processes for producing these thermoplastic elastomers or foams or foamed pellets composed of the mentioned thermoplastic elastomers are likewise known per se to those skilled in the art.

Suitable thermoplastic polyetheresters and polyesteresters can be produced according to any standard methods known from the literature by transesterification or esterification of aromatic and aliphatic dicarboxylic acids having 4 to 20 carbon atoms or esters thereof with suitable aliphatic and aromatic di-and polyols (cf. “Polymer Chemistry”, Interscience Publ., New York, 1961, pp. 111-127; Kunststoffhandbuch [Plastics Handbook], volume VIII, C. Hanser Verlag, Munich 1973 and Journal of Polymer Science, Part A1, 4, pages 1851-1859 (1966)). Examples of suitable aromatic dicarboxylic acids include phthalic acid, iso-and terephthalic acid and esters thereof. Examples of suitable aliphatic dicarboxylic acids include cyclohexane-1,4-dicarboxylic acid, adipic acid, sebacic acid, azelaic acid, and decanedicarboxylic acid as saturated dicarboxylic acids, and maleic acid, fumaric acid, aconitic acid, itaconic acid, tetrahydrophthalic acid, and tetrahydroterephthalic acid as unsaturated dicarboxylic acids.

Examples of suitable diol components include diols of the general formula HO—(CH2)n—OH where n=2 to 20, such as ethylene glycol, propane-1,3-diol, butane-1,4-diol or hexane-1,6-diol, polyetherols of the general formula HO—(CH2)n-O—(CH2 m-OH where n is equal or unequal to m and n and m=2 to 20, unsaturated diols and polyetherols, for example butene-1,4-diol; diols and polyetherols comprising aromatic units; and polyesterols.

As well as the recited carboxylic acids and esters thereof and the recited alcohols, it is possible to use any other standard representatives of these classes of compound for providing the polyetheresters and polyesteresters used in accordance with the invention.

The thermoplastic polyetheramides can be obtained according to any standard methods known from the literature by reaction of amines and carboxylic acids or esters thereof. Amines and/or carboxylic acid here additionally comprise ether units of the type R—O—R, where R=organic radical (aliphatic and/or aromatic). In general, monomers of the following classes of compound are used: HOOC—R′—NH2 where R′ may be aromatic and aliphatic, preferably comprising ether units of type R—O—R, where R=organic radical (aliphatic and/or aromatic); aromatic dicarboxylic acids including, for example, phthalic acid, iso-and terephthalic acid or esters thereof and aromatic dicarboxylic acids comprising ether units of type R—O—R, where R=organic radical (aliphatic and/or aromatic); aliphatic dicarboxylic acids including, for example, cyclohexane-1,4-dicarboxylic acid, adipic acid, sebacic acid, azelaic acid, and decanedicarboxylic acid as saturated dicarboxylic acids, and maleic acid, fumaric acid, aconitic acid, itaconic acid, tetrahydrophthalic acid, and tetrahydroterephthalic acid as unsaturated and aliphatic dicarboxylic acids comprising ether units of type R—O—R, where R=organic radical (aliphatic and/or aromatic); diamines of the general formula H2N—R″—NH2 where R″ may be aromatic and aliphatic, preferably comprising ether units of type R—O—R, where R=organic radical (aliphatic and/or aromatic); lactams, for example ε-caprolactam, pyrrolidone or laurolactam; and amino acids.

As well as the recited carboxylic acids and esters thereof and the recited amines, lactams and amino acids, it is possible to use any other standard representatives of these classes of compound for providing the polyetheramine used in accordance with the invention.

The thermoplastic elastomers having block copolymer structure that are used in accordance with the invention preferably comprise vinylaromatic units, butadiene units, and isoprene units, and also polyolefin units and vinylic units, for example ethylene, propylene, and vinyl acetate units. Preference is given to styrene-butadiene copolymers.

The thermoplastic elastomers having block copolymer structure, polyetheramides, polyetheresters and polyesteresters that are used in accordance with the invention are preferably selected such that the melting points thereof are ≤300° C., preferably ≤250° C., especially ≤220° C.

The thermoplastic elastomers having block copolymer structure, polyetheramides, polyetheresters and polyesteresters that are used in accordance with the invention may be semicrystalline or amorphous.

Suitable thermoplastic olefin-based elastomers (TPO) have in particular a hard segment and a soft segment, the hard segment being for example a polyolefin such as polypropylene and polyethylene and the soft segment being a rubber component such as ethylene-propylene rubber. Blends of a polyolefin and a rubber component, dynamically crosslinked types, and polymerized types are suitable.

Suitable structures are for example those in which an ethylene-propylene rubber (EPM) is dispersed in polypropylene; structures in which a crosslinked or partially crosslinked ethylene-propylene-diene rubber (EPDM) is dispersed in polypropylene; random copolymers of ethylene and an a-olefin such as propylene and butene; or block copolymers of a polyethylene block and an ethylene/a-olefin copolymer block. Examples of suitable a-olefins are propylene, 1-butene, 1-pentene, 1-hexene, 1-heptene, 1-octene, 1-nonene, 1-n-decene, 3-methyl-1-butene and 4-methyl-1-pentene or mixtures of these olefins.

Suitable semicrystalline polyolefins are for example homopolymers of ethylene or propylene or copolymers comprising monomeric ethylene and/or propylene units. Examples are copolymers of ethylene and propylene or an a-olefin having 4-12 carbon atoms and copolymers of propylene and an a-olefin having 4-12 carbon atoms. The concentration of ethylene or propylene in the copolymers is here preferably sufficiently high that the copolymer is semicrystalline.

In the case of random copolymers, an ethylene content or a propylene content of about 70 mol % or more is for example suitable.

Suitable polypropylenes are propylene homopolymers or also polypropylene block copolymers, for example random copolymers of propylene and up to about 6 mol % of ethylene.

Suitable thermoplastic styrene block copolymers usually include polystyrene blocks and elastomeric blocks. Suitable styrene blocks are selected for example from polystyrene, substituted polystyrenes, poly (a-methylstyrenes), ring-halogenated styrenes, and ring-alkylated styrenes. Suitable elastomeric blocks are for example polydiene blocks such as polybutadienes and polyisoprenes, poly (ethylene/butylene) copolymers and poly (ethylene/propylene) copolymers, polyisobutylenes, or else polypropylene sulfides or polydiethylsiloxanes.

In the context of the present invention, the thermoplastic elastomer (TPE-1) is particularly advantageously a thermoplastic polyurethane.

Thermoplastic polyurethanes are known from the prior art. They are typically obtained by reaction of a polyisocyanate composition with a polyol composition, where the polyol composition typically comprises a polyol and a chain extender.

According to the invention, the thermoplastic elastomers used may comprise other additives, for example customary auxiliaries such as surface-active substances, fillers, flame retardants, nucleating agents, oxidation stabilizers, lubricants and demolding aids, dyes and pigments, optionally stabilizers, for example against hydrolysis, light, heat or discoloration, inorganic and/or organic fillers, reinforcers, and plasticizers. Suitable auxiliary and additive substances may be found for example in Kunststoffhandbuch [Plastics Handbook], volume VII, edited by Vieweg and Höchtlen, Carl Hanser Verlag, Munich 1966 (pp. 103-113).

In the context of the present invention, it was found that, in addition to the storage modulus (G modulus) and the density of the foam, the comfort factor in particular has a significant influence on seating comfort.

According to the invention, it was found to be advantageous when, in the measurement in accordance with Reference Example 5 after the 4th cycle, the foam has a compression hardness at 10% compression of less than or equal to 22 kPa, more preferably less than 20 kPa or less than 15 kPa. In the context of the present invention, “after the 4th cycle” is understood to mean that the corresponding value may also already have been reached in a previous measurement cycle, i.e. that the measured value falls within the range of the invention no later than at the 4th measurement or after the 4th cycle.

Preferably, the foam has after the 4th cycle a compression hardness at 25% compression of less than or equal to 65 kPa, determined in accordance with Reference Example 5.

In a further embodiment, the present invention accordingly relates also to a molded article as described hereinabove, wherein the foam has after the 4th cycle a compression hardness at 10% compression of less than or equal to 22 kPa, determined in accordance with Reference Example 5.

In a further embodiment, the present invention accordingly relates also to a molded article as described hereinabove, wherein the foam has after the 4th cycle a compression hardness at 25% compression of less than or equal to 65 kPa, determined in accordance with Reference Example 5.

In one embodiment, the present invention relates also to a molded article as described hereinabove, wherein the foam has a compression hardness at 65% compression within the range from 300 to 700 kPa, determined after the 4th cycle in accordance with Reference Example 5.

In one embodiment, the present invention relates also to a molded article as described hereinabove, wherein the foam has a compression hardness at 10% compression within the range from 1 to 20 kPa, determined after the 4th cycle in accordance with Reference Example 5.

According to the invention, it was found that the compression hardness of the molded article is influenced by the combination of the G modulus of the foam of the employed thermoplastic elastomer (TPE-1) and the adjustment of the density of the foam within the range of the invention. The density of the foam can according to the invention be influenced for example by suitable conditions during production of the foam.

It is also possible in the context of the present invention to use a foamed pellet material that undergoes fusion by suitable measures, wherein the foam or the molded article is adjusted to a suitable density during fusion.

According to the invention, the molded article may comprise the beads of the foamed pellet material in loose form. In this case, the molded article may for example comprise a suitable shell that essentially determines the shape of the molded article.

In one embodiment, the present invention relates also to a molded article as described hereinabove, wherein the molded article comprises a shell and the beads of the foamed pellet material.

The material and the shape of the shell may within the scope of the present invention vary within wide ranges, provided the shell can be closed and is suitable for forming a molded article with loose beads of the foamed pellet material.

According to the invention, the beads of the foamed pellet material may for example be welded to form a foam of a suitable density. It is within the scope of the present invention also possible for the foamed pellet material to be subjected to a treatment before the welding or bonding, for example a thermal treatment, an irradiation or a treatment with a solvent.

In one embodiment, the present invention relates also to a molded article as described hereinabove, wherein the foam consists of welded beads.

According to the invention it is also possible for a foamed pellet material to be embedded in a matrix and for the foam to be a hybrid foam.

In one embodiment, the present invention relates also to a molded article as described hereinabove, wherein the foam is a hybrid foam comprising a foamed pellet material composed of a thermoplastic elastomer (TPE-1).

Materials comprising a foamed pellet material and a matrix material are in the context of this invention referred to as hybrid materials. The matrix material may here be composed of a compact material or likewise of a foam.

Polymers (PM) suitable as matrix material are known per se to those skilled in the art. Suitable in the context of the present invention are for example ethylene-vinyl acetate copolymers, epoxy-based binders or else polyurethanes. Polyurethane foams or else compact polyurethanes, for example resilient polyurethanes, are suitable here in accordance with the invention. According to the invention, the polymers used as matrix material may comprise other additives, for example customary auxiliaries such as surface-active substances, fillers, flame retardants, nucleating agents, oxidation stabilizers, lubricants and demolding aids, dyes and pigments, optionally stabilizers, for example against hydrolysis, light, heat or discoloration, inorganic and/or organic fillers, reinforcers and plasticizers. Suitable auxiliary and additive substances may be found for example in Kunststoffhandbuch [Plastics Handbook], volume VII, edited by Vieweg and Höchtlen, Carl Hanser Verlag, Munich 1966 (pp. 103-113).

According to the invention, the polymer (PM) is chosen so as to ensure sufficient adhesion between the foamed pellet material and the matrix such that a hybrid material that is mechanically stable at least on the surface is obtained.

The matrix may completely or partially surround the foamed pellet material. According to the invention, the hybrid material may comprise further components, for example further fillers or else pellets. The hybrid material may in accordance with the invention also comprise mixtures of different polymers (PM). The hybrid material may also comprise mixtures of foamed pellets.

Foamed pellets that may be used besides the foamed pellet material according to the present invention are known per se to those skilled in the art. Foamed pellets composed of thermoplastic elastomers, in particular thermoplastic polyurethanes, are particularly suitable in the context of the present invention.

Accordingly also suitable in the context of the present invention is a hybrid material comprising a matrix composed of a polymer (PM), a foamed pellet material composed of a thermoplastic elastomer (TPE-1), and a further foamed pellet material composed of a thermoplastic polyurethane.

The matrix may within the scope of the present invention consist for example of a polymer (PM). Examples of suitable matrix materials in the context of the present invention are elastomers or foams, especially foams based on polyurethanes, for example elastomers such as ethylene-vinyl acetate copolymers or else thermoplastic or elastic polyurethanes.

Suitable matrix materials are known per se to those skilled in the art. For example, epoxy-based or polyurethane-based adhesive systems known per se may be used.

Suitable thermoplastic and resilient polyurethanes are known per se to those skilled in the art. Suitable polyurethanes are described for example in “Kunststoffhandbuch” [Plastics handbook], volume 7, “Polyurethane” [Polyurethanes], Carl Hanser Verlag, 3rd edition 1993, chapter 3.

The polymer (PM) is in the context of the present invention preferably a polyurethane. For the purposes of the invention, the term “polyurethane” encompasses all known polyisocyanate polyaddition products. These include, in particular, solid polyisocyanate polyaddition products, such as viscoelastic gels or thermoplastic polyurethanes, and resilient foams based on polyisocyanate polyaddition products, such as flexible foams, semirigid foams or integral foams. For the purposes of the invention, “polyurethanes” are further understood as meaning resilient polymer blends comprising polyurethanes and further polymers, and also foams composed of these polymer blends. The matrix is preferably a hardened, compact polyurethane binder, a resilient polyurethane foam or a gel.

A “polyurethane binder” is in the context of the present invention understood as meaning a mixture that consists to an extent of at least 50% by weight, preferably to an extent of at least 80% by weight, and in particular to an extent of at least 95% by weight, of a prepolymer having isocyanate groups, referred to hereinafter as isocyanate prepolymer. The viscosity of the polyurethane binder of the invention is preferably within a range from 500 to 4000 mPa·s, more preferably from 1000 to 3000 mPa·s, measured at 25° C. in accordance with DIN 53019-1:2008-09.

Polyurethane foams suitable in the context of the invention are known per se to those skilled in the art.

The density of the matrix material is preferably within the range from 2 to 0.001 g/cm³. The matrix material is particularly preferably a resilient foam or an integral foam having a density within the range from 0.8 to 0.1 g/cm³, in particular from 0.6 to 0.1 g/cm³, or a compact material, for example a hardened polyurethane binder.

Foams are particularly suitable as matrix material. Hybrid materials comprising a matrix material composed of a polyurethane foam preferably have good adhesion between the matrix material and foamed pellet material.

A hybrid material suitable according to the invention, comprising a polymer (PM) as matrix and a foamed pellet material, may for example be produced by mixing the components used to produce the polymer (PM) and the foamed pellet material optionally with further components, and reacting them to give the hybrid material, the reaction preferably being carried out under conditions under which the foamed pellet material is essentially stable.

Suitable processes and reaction conditions for producing the polymer (PM), especially an ethylene-vinyl acetate copolymer or a polyurethane, are known per se to those skilled in the art.

In a preferred embodiment, the hybrid materials suitable according to the invention are integral foams, especially integral foams based on polyurethanes. Suitable processes for producing integral foams are known per se to those skilled in the art. The integral foams are preferably produced by the one-shot process using the low-pressure or high-pressure technique in closed, advantageously temperature-controlled molds. The molds are usually made of metal, for example aluminum or steel. These procedures are described for example by Piechota and Röhr in “Integralschaumstoff” [Integral foam], Carl-Hanser-Verlag, Munich, Vienna, 1975, or in “Kunststoff-Handbuch” [Plastics handbook], volume 7, “Polyurethane” [Polyurethanes], 3rd edition, 1993, chapter 7.

It is thus possible to produce hybrid materials having a matrix composed of a polymer (PM), with the foamed pellet material of the invention present therein. The foamed pellet material of the invention can be readily used in a process for producing a hybrid material, for example by compression molding.

In a hybrid material suitable according to the invention, the proportion by volume of the foamed pellet material is preferably 20 percent by volume or more, more preferably 50 percent by volume or more, preferably 80 percent by volume or more, and in particular 90 percent by volume or more, in each case based on the volume of the hybrid system.

The hybrid materials suitable as foam in the context of the present invention, in particular hybrid materials having a matrix composed of cellular polyurethane, are characterized by very good adhesion of the matrix material to the foamed pellet material of the invention. As a result, there is preferably no tearing of a hybrid material of the invention at the interface of the matrix material and foamed pellet material. This makes it possible to produce hybrid materials in which mechanical properties such as tear-propagation resistance and elasticity are improved compared to conventional polymer materials, especially conventional polyurethane materials, of the same density.

The rebound resilience of hybrid materials of the invention in the form of integral foams is preferably greater than 30% and more preferably greater than 50% in accordance with DIN53512:2000-04.

The properties of the hybrid materials may vary within wide ranges depending on the polymer (PM) used, and can be adjusted within wide limits, in particular by varying the size, shape, and nature of the expanded pellet material or else by adding further additives, for example by also adding further non-foamed pellet materials such as plastics pellets, for example rubber pellets.

In a further aspect, the present invention relates also to a process for producing a molded article comprising the steps of
(i) providing a foam composed of a thermoplastic elastomer (TPE-1), wherein the foam has a storage modulus (G modulus) at 25° C. and 1 Hz within the range from 0.01 to 0.5 MPa, determined in accordance with Reference Example 1 (TPE molding), and a molding density within the range from 20 to 400 kg/m³, determined in accordance with Reference Example 2, wherein the foam has a comfort factor of greater than 4, determined in accordance with Reference Example 3;
(ii) processing the foam into a molded article.

With regard to preferred embodiments, reference is made to the statements above.

In the context of the present invention, the process of the invention comprises the steps (i) and (ii). The foam composed of a thermoplastic elastomer (TPE-1) provided in accordance with step (i) may be a slabstock foam or else a foamed pellet material. According to the invention, it is also possible for the foam to be processed before being provided in step (i). In the context of the present invention, the foam may for example also be a welded or bonded foamed pellet material or else a foamed pellet material embedded in a matrix foam or in a matrix polymer. Thus, it is also possible within the scope of the present invention, for example, to initially use a foam composed of a thermoplastic elastomer (TPE-1) that has a density and/or a G modulus and/or a comfort factor outside the range of the invention and to adjust the density, the G modulus, and the comfort factor through appropriate treatment.

In one embodiment, the present invention relates also to a process for producing a molded article as described hereinabove, wherein the foam is a foamed pellet material.

The present invention relates also to a process for producing a molded article, comprising the steps of
(i) providing a foam composed of a thermoplastic elastomer (TPE-1), wherein the foam has a storage modulus (G modulus) at 25° C. and 1 Hz within the range from 0.01 to 0.5 MPa, determined in accordance with Reference Example 1 (TPE molding), and a molding density within the range from 20 to 400 kg/m³, determined in accordance with Reference Example 2, wherein the foam is a foamed pellet material;
(ii) processing the foam into a molded article.

Suitable processes for producing a molded article from a foamed pellet material are known per se to those skilled in the art.

When the molded article comprises a shell and the beads of the foamed pellet material in loose form, it is in accordance with step (ii) possible for example to fill the shell in order to form the molded article. Suitable measures for filling a shell with a foamed pellet material are known per se to those skilled in the art. For example, the shell can be filled by pouring, layering, pushing, pressing, robotic positioning, spinning or suction.

Within the scope of the present invention, it is also possible for step (i) and step (ii) of the process to be executed simultaneously, that is to say, for example, for a foamed pellet material to first be provided in accordance with step (i) and then in accordance with step (ii) to be processed into a molded article by welding, bonding or foaming.

In one embodiment, the present invention relates also to a process as described hereinabove, wherein the processing in accordance with step (ii) takes place by means of welding, foaming or bonding the beads of the foamed pellet material.

According to the invention, the molded article is produced for example by first providing a mold and then pouring the foamed pellet material into the mold. The amount of foamed pellet material that is poured into the mold is tailored to the size of the mold and the desired density of the molding. Within the scope of the present invention, the process may also include further steps, for example temperature adjustments. Within the scope of the present invention, the molded article may also comprise further components. Accordingly, further moldings or foamed beads composed of a different material may be used in production.

The processing in step (ii) preferably takes place in a closed mold, wherein the fusion can be achieved through steam, hot air (for example as described in EP1979401B1), variothermal welding or high-energy radiation (for example microwaves or radio waves).

The temperature during fusion of the foamed pellet material is preferably below or close to the melting temperature of the polymer from which the foamed pellet material was produced.

Welding by means of high-energy radiation is generally effected in the frequency range of microwaves or radio waves, optionally in the presence of water or of other polar liquids, for example microwave-absorbing hydrocarbons having polar groups (for example esters of carboxylic acids and diols or triols or glycols and liquid polyethylene glycols), and can be effected in an analogous manner to the processes described in EP3053732A or WO16146537.

For example, the molded article is produced by welding at a temperature within the range from 100 to 170° C. The temperature during welding of the expanded beads is preferably between 100° C. and 140° C.

The welding may for example be effected by the components being welded to one another in a closed mold under the action of heat and optionally under pressure. To do this, the components, i.e. at least the foamed pellet material, are poured into the mold and, after closing the mold, steam or hot air is introduced, which results in the beads of the foamed pellet material expanding further and welding together to form the foam. According to the invention, it is also possible, depending on the thickness of the component, to heat a mold from the outside with a heating medium such as water or oil in order to weld the beads.

The process according to the invention may comprise further steps, for example temperature adjustments.

Further embodiments in accordance with standard methods are possible here; the processes used in the production of the starting materials may be integrated directly into production.

The present invention further relates to a molded article obtained or obtainable by a process as described hereinabove.

The molded articles of the invention are particularly suitable as cushioning elements. The molded articles of the invention are also suitable as a shoe sole, part of a shoe sole, bicycle saddle, cushioning, mattress, padding, backrest, arm pad, pad, underlay, handle, protective film, protectors, damping element or as component in the automotive interior and exterior sector.

In a further embodiment, the present invention accordingly relates also to a molded article as described hereinabove, wherein the molded article is a shoe sole, part of a shoe sole, a bicycle saddle, cushioning, a mattress, padding, backrest, arm pad, pad, underlay, handle, protective film, protectors, damping element or a component in the automotive interior and exterior sector.

In a further aspect, the present invention relates also to the use of a molded article of the invention for producing floors, mattresses, seating furniture, a bicycle saddle, car seats, motorcycle seats, components of a shoe, as shoe inserts, packaging or shock absorbers.

Further embodiments of the present invention can be found throughout the specification and the examples. It will be appreciated that the features of the subject matter/process/uses of the invention recited hereinabove and those elucidated hereinbelow may be used not only in the combination specified in each case but also in other combinations without departing from the scope of the invention. Thus, for example, the combination of a preferred feature with a particularly preferred feature, or of a feature not characterized further with a particularly preferred feature etc., is also encompassed implicitly even if this combination is not mentioned explicitly.

Illustrative embodiments of the present invention are detailed hereinbelow, but do not limit the present invention. In particular, the present invention also encompasses those embodiments that result from the dependency references and hence combinations specified hereinbelow.
1. A molded article comprising a foam composed of a thermoplastic elastomer (TPE-1), wherein the foam has a storage modulus (G modulus) at 25° C. and 1 Hz within the range from 0.01 to 0.5 MPa, determined in accordance with Reference Example 1 (TPE molding), and a molding density within the range from 20 to 400 kg/m³, determined in accordance with Reference Example 2, wherein the foam has a comfort factor of greater than 4, determined in accordance with Reference Example 3.
2. The molded article according to embodiment 1, wherein the foam has a compression hardness at 10% compression of less than or equal to 22 kPa, determined after the 4th cycle of measurement in accordance with Reference Example 5.
3. The molded article according to either of embodiments 1 or 2, wherein the foam has a compression hardness at 25% compression of less than or equal to 65 kPa, determined after the 4th cycle in accordance with Reference Example 5.
4. The molded article according to any of embodiments 1 to 3, wherein the foam is a foamed pellet material.
5. The molded article according to any of embodiments 1 to 4, wherein the thermoplastic elastomer (TPE-1) is selected from the group consisting of thermoplastic polyurethanes, thermoplastic polyetheramides, polyetheresters, polyesteresters, thermoplastic olefin-based elastomers, crosslinked thermoplastic olefin-based elastomers, thermoplastic vulcanizates or thermoplastic styrene-butadiene block copolymers.
6. The molded article according to any of embodiments 1 to 5, wherein the thermoplastic elastomer (TPE-1) is selected from the group consisting of thermoplastic polyurethanes, thermoplastic polyetheramides, polyetheresters, polyesteresters, or thermoplastic styrene-butadiene block copolymers.
7. The molded article according to any of embodiments 1 to 6, wherein the thermoplastic elastomer (TPE-1) in the compact state has a G modulus within the range from 0.8 to 8.5 MPa, determined in accordance with Reference Example 6.
8. The molded article according to any of embodiments 1 to 7, wherein the molded article comprises a shell and the beads of the foamed pellet material.
9. The molded article according to any of embodiments 1 to 7, wherein the foam consists of welded beads of a foamed pellet material.
10. The molded article according to any of embodiments 1 to 7, wherein the foam is a hybrid foam comprising a foamed pellet material composed of a thermoplastic elastomer (TPE-1).
11. A process for producing a molded article comprising the steps of
   (i) providing a foam composed of a thermoplastic elastomer (TPE-1), wherein the foam has a storage modulus (G modulus) at 25° C. and 1 Hz within the range from 0.01 to 0.5 MPa, determined in accordance with Reference Example 1 (TPE molding), and a molding density within the range from 20 to 400 kg/m³, determined in accordance with Reference Example 2, wherein the foam has a comfort factor of greater than 4, determined in accordance with Reference Example 3;
   (ii) processing the foam into a molded article.
12. The process according to embodiment 11, wherein the foam is a foamed pellet material.
13. The process according to embodiment 12, wherein the processing in accordance with step (ii) takes place by means of welding, foaming or bonding the beads of the foamed pellet material.
14. The process according to any of embodiments 11 to 13, wherein the foam has a compression hardness at 10% compression of less than or equal to 22 kPa, determined after the 4th cycle of measurement in accordance with Reference Example 5.
15. The process according to any of embodiments 11 to 14, wherein the foam has a compression hardness at 25% compression of less than or equal to 65 kPa, determined after the 4th cycle in accordance with Reference Example 5.
16. The process according to any of embodiments 11 to 15, wherein the thermoplastic elastomer (TPE-1) is selected from the group consisting of thermoplastic polyurethanes, thermoplastic polyetheramides, polyetheresters, polyesteresters, thermoplastic olefin-based elastomers, crosslinked thermoplastic olefin-based elastomers, thermoplastic vulcanizates or thermoplastic styrene-butadiene block copolymers.
17. The process according to any of embodiments 11 to 16, wherein the thermoplastic elastomer (TPE-1) is selected from the group consisting of thermoplastic polyurethanes, thermoplastic polyetheramides, polyetheresters, polyesteresters, or thermoplastic styrene-butadiene block copolymers.
18. The process according to any of embodiments 11 to 17, wherein the thermoplastic elastomer (TPE-1) in the compact state has a G modulus within the range from 0.8 to 8.5 MPa, determined in accordance with Reference Example 6.
19. A molded article obtained or obtainable by a process according to any of embodiments 11 to 18.
20. The molded article according to embodiment 17, wherein the molded article is a shoe sole, part of a shoe sole, a bicycle saddle, cushioning, a mattress, padding, backrest, arm pad, pad, underlay, handle, protective film, a protector, damping element, a fall protection mat, an elastic insulating material, sealing material or a component in the automotive interior and exterior sector.
21. The use of a molded article according to any of embodiments 1 to 10 or 19 or 20 for producing floors, mattresses, seating furniture, a bicycle saddle, car seats, motorcycle seats, components of a shoe, as shoe inserts, packaging, shock absorbers, protectors, fall protection mats, elastic insulating material or sealing material.
22. A molded article comprising a foam composed of a thermoplastic elastomer (TPE-1), wherein the foam has a storage modulus (G modulus) at 25° C. and 1 Hz within the range from 0.01 to 0.5 MPa, determined in accordance with Reference Example 1 (TPE molding), and a molding density within the range from 20 to 400 kg/m³, determined in accordance with Reference Example 2, wherein the foam is a foamed pellet material.
23. The molded article according to embodiment 22, wherein the thermoplastic elastomer (TPE-1) is selected from the group consisting of thermoplastic polyurethanes, thermoplastic polyetheramides, polyetheresters, polyesteresters, thermoplastic olefin-based elastomers, crosslinked thermoplastic olefin-based elastomers, thermoplastic vulcanizates or thermoplastic styrene-butadiene block copolymers.
24. The molded article according to either of embodiments 22 or 23, wherein the thermoplastic elastomer (TPE-1) is selected from the group consisting of thermoplastic polyurethanes, thermoplastic polyetheramides, polyetheresters, polyesteresters, or thermoplastic styrene-butadiene block copolymers.
25. The molded article according to any of embodiments 22 to 24, wherein the thermoplastic elastomer (TPE-1) in the compact state has a G modulus within the range from 0.8 to 8.5 MPa, determined in accordance with Reference Example 6.
26. The molded article according to any of embodiments 22 to 25, wherein the molded article comprises a shell and the beads of the foamed pellet material.
27. The molded article according to any of embodiments 22 to 25, wherein the foam consists of welded beads of a foamed pellet material.
28. The molded article according to any of embodiments 22 to 25, wherein the foam is a hybrid foam comprising a foamed pellet material composed of a thermoplastic elastomer (TPE-1).
29. A process for producing a molded article comprising the steps of
   (i) providing a foam composed of a thermoplastic elastomer (TPE-1), wherein the foam has a storage modulus (G modulus) at 25° C. and 1 Hz within the range from 0.01 to 0.5 MPa, determined in accordance with Reference Example 1 (TPE molding), and a molding density within the range from 20 to 400 kg/m³, determined in accordance with Reference Example 2, wherein the foam is a foamed pellet material;
   (ii) processing the foam into a molded article.
30. The process according to embodiment 29, wherein the processing in accordance with step (ii) takes place by means of welding, foaming or bonding the beads of the foamed pellet material.
31. The process according to any of embodiments 29 to 31, wherein the thermoplastic elastomer (TPE-1) is selected from the group consisting of thermoplastic polyurethanes, thermoplastic polyetheramides, polyetheresters, polyesteresters, thermoplastic olefin-based elastomers, crosslinked thermoplastic olefin-based elastomers, thermoplastic vulcanizates or thermoplastic styrene-butadiene block copolymers.
32. The process according to any of embodiments 29 to 31, wherein the thermoplastic elastomer (TPE-1) is selected from the group consisting of thermoplastic polyurethanes, thermoplastic polyetheramides, polyetheresters, polyesteresters, or thermoplastic styrene-butadiene block copolymers.
33. The process according to any of embodiments 29 to 32, wherein the thermoplastic elastomer (TPE-1) in the compact state has a G modulus within the range from 0.8 to 8.5 MPa, determined in accordance with Reference Example 6.
34. A molded article obtained or obtainable by a process according to any of embodiments 29 to 33.
35. The molded article according to embodiment 34, wherein the molded article is a shoe sole, part of a shoe sole, a bicycle saddle, cushioning, a mattress, padding, backrest, arm pad, pad, underlay, handle, protective film, a protector, damping element, a fall protection mat, an elastic insulating material, sealing material or a component in the automotive interior and exterior sector.
36. The use of a molded article according to any of embodiments 22 to 28 or 34 or 35 for producing floors, mattresses, seating furniture, a bicycle saddle, car seats, motorcycle seats, components of a shoe, as shoe inserts, packaging, shock absorbers, protectors, fall protection mats, elastic insulating material or sealing material.

The examples that follow serve to illustrate the invention but are in no way limiting with regard to the subject matter of the present invention.

### EXAMPLES

### I. Production Examples

### 1. Preparation of the Example Materials and Comparative Materials

The production of the example materials TPU 1 to 4 specified hereinbelow was carried out in a ZSK58 MC twin-screw extruder from Coperion, having a processing length of 48D (12 barrels).

The melt was discharged from the extruder by means of a gear pump. After filtration of the melt, the polymer melt was processed by means of an underwater pelletization system into pellets that were dried continuously at 40-90° C. in a heated fluidized bed.

The polyol, the chain extender and the diisocyanate and optionally a catalyst were metered into the first zone. The supply of further additives took place in zone 8.

The barrel temperatures are in the range of 150-230° C. The melt is discharged into the underwater pelletization system with melt temperatures of 180-210° C. The screw speed is between 180 and 240 min⁻¹. The throughput is in the range of 180-220 kg/h. The amounts of the feedstocks used for the production of the example materials are summarized in Table 1.

TABLE 1
Composition of the materials used

| Feedstocks | TPU 1 | TPU 2 | TPU 3 | TPU 4 | TPU 5 |
|---|---|---|---|---|---|
| Polyether polyol having an OH value of | 1000 | | 1000 | 1000 | 1000 |
| 112.2 and exclusively primary OH groups | | | | | |
| (based on tetramethylene oxide, | | | | | |
| functionality: 2) [parts by weight] | | | | | |
| Polyester polyol having an OH value of 56 | | 1000 | | | |
| and exclusively primary OH groups (based | | | | | |
| on ethane-1,2-diol and butane-1,4-diol in a | | | | | |
| ratio of 1:1 and adipic acid, functionality: 2) | | | | | |
| [parts by weight] | | | | | |
| Aromatic isocyanate (methylene diphenyl | 455.5 | 260 | 500 | 630 | 503 |
| 4,4′-diisocyanate) [parts by weight] | | | | | |
| Butane-1,4-diol [parts by weight] | | | 89.9 | 136.74 | 91.1 |
| Monoethylene glycol [parts by weight] | 51.03 | 32.23 | | | |
| Acetyl tributyl citrate [parts by weight] | 382.86 | 231.17 | | | |
| Sterically hindered amine as light stabilizer | 3.83 | | 3.28 | | 3.28 |
| (HALS) [parts by weight] | | | | | |
| Phenol-based primary antioxidant | 9.57 | 13.08 | 16.1 | 17.85 | 16.4 |
| [parts by weight] | | | | | |
| Wax based on distearylethylenediamide | 5.74 | 4.62 | 0.4 | 0.89 | 1.64 |
| [parts by weight] | | | | | |
| Oxalanilide-based UV absorber | 5.74 | | 4.93 | | 4.93 |
| [parts by weight] | | | | | |
| Carbodiimide-based hydrolysis inhibitor | | 10 | | | |
| [parts by weight] | | | | | |
| Tin(II) isooctoate (50% in dioctyl adipate) | 50 ppm | 50 ppm | 50 ppm | 50 ppm | 50 ppm |
| [parts by weight] | | | | | |

This blending and synthesis produces thermoplastic polyurethanes having the properties listed in Table 2. The storage modulus (G modulus) was determined in accordance with Reference Example 1 (compact pellet material). The melt flow rate (MFR) was measured on the pellets in accordance with DIN EN ISO 1133-2:2012. The conditions employed are listed in Table 2.

TABLE 2
Properties of the produced compact example materials

| | | MFR (190° C., 3.8 kg) | MFR (190° C., 21.6 kg) |
|---|---|---|---|
| | G modulus | DIN EN ISO | DIN EN ISO |
| | at 25° C. | 1133-2: 2012 | 1133-2: 2012 |
| TPU 1 | 1.9 MPa | 28 | |
| TPU 2 | 1.3 MPa | 145 | |
| TPU 3 | 7.3 MPa | | 31 |
| TPU 4 | 9.5 MPa | | 76 |
| TPU 5 | 8.3 MPa | | 38 |

### 2. General Method of Production for the Examples and Comparative Examples According to the Extrusion Process

After the feedstocks had been produced, they were further processed into expanded thermoplastic polyurethane pellets as follows. For this, the dried TPUs were mixed in a twin-screw extruder (ZSK 40, Coperion) with further additives 0.2% talc (particle size 5.6 μm-D50, volume distribution) as nucleating agent, optionally a TPU that in a separate extrusion process had been admixed with 4,4′-diphenylmethane diisocyanate having an average functionality of 2.05 (additive 1), and optionally with triacetin as plasticizer (additive 2) and optionally with a polystyrene (melt flow rate, 200° C./5 kg: 3 g/10 min) (additive 3) and melted within a temperature range from 130 to 220° C. As the blowing agent, CO₂ and N₂ were injected into the melt in the extruder and blended with the thermoplastic polyurethane and the other additives to form a homogeneous melt. The composition of the individual examples and comparative examples is listed in Table 3. The material was then pressed using a gear pump (approx. 130-200° C. depending on the material composition) into a die plate (130-200° C. depending on the material composition), cut into pellets in the cutting chamber of the underwater pelletization system (UWP), and transported away with the temperature-controlled and pressurized water, undergoing expansion in the process. After separating the expanded pellets from the water by means of a centrifugal dryer, the expanded pellets are dried at 50-60° C. for 2 h. The water temperature and the water pressure used for the individual examples and comparative examples, the amount of CO₂ and N₂, and the bead mass and the resulting bulk density in accordance with Reference Example 4 are listed in Table 3.

The foamed pellet material was produced by the autoclave process, a standard process known in the prior art, through
(i) providing a TPU composition of the invention;
(ii) impregnating the composition with a blowing agent under pressure;
(iii) expanding the composition by means of a pressure drop.

The amount of blowing agent is preferably 0.1 to 40, especially 0.5 to 35, and particularly preferably 1 to 30, parts by weight based on 100 parts by weight of the amount of composition (Z) used.

The impregnation in step (ii) may take place in the presence of water and optionally suspension auxiliaries or solely in the presence of the blowing agent and in the absence of water.

The performance of the process in suspension is known to those skilled in the art and has been described extensively, for example in WO2007/082838.

### 3. General Method of Production for the Examples and Comparative Examples According to the Autoclave Process (Tank Process)

100.0 parts by weight (corresponding to 27.5% by weight based on the overall suspension without blowing agent) of the pellet material, 257 parts by weight (corresponding to 70.6% by weight based on the overall suspension without blowing agent) of water, 6.7 parts by weight (corresponding to 1.8% by weight based on the overall suspension without blowing agent) of calcium carbonate (suspending agent), 0.13 parts by weight (corresponding to 0.04% by weight based on the overall suspension without blowing agent) of a surface-active substance (Lutensol AT 25, suspension auxiliary), and the appropriate amount of butane as blowing agent (based on the amount of pellet material used) were heated while stirring.

Nitrogen was then additionally injected into the liquid phase at 50° C. and the internal pressure was adjusted to a predefined pressure (800 kPa). This is followed, on reaching the impregnation temperature (IMT) and optionally after observing a hold time (HZ), and at the impregnation pressure (IMP) established at the end, by expansion via an expansion device. The gas space is here adjusted to a fixed expulsion pressure (AP) and kept constant during the expansion. The expansion jet downstream of the expansion device may optionally be cooled with a defined volume flow rate of water at a defined temperature (water quench).

The hold time defines the time at which the temperature of the liquid phase is within a temperature range from 5° C. below the impregnation temperature to 2° C. above the impregnation temperature.

After removal of the suspending agent/suspension auxiliary system (dispersant/surfactant) and drying, the bulk density (SD) of the resulting foam beads is measured in accordance with Reference Example 4.

The exact production parameters and the bulk density of the resulting batches are listed in Table 4.

### Tables 3a and 3b: Data for the Examples and Comparative Examples (Extrusion Process)

| | | | Proportion | Proportion | Proportion | |
|---|---|---|---|---|---|---|
| | | Proportion | of | of | of | Bead |
| eTPU | TPU | of ex. m. | additive 1 | additive 2 | additive 3 | mass |
| beads | used | (% by wt.) | (% by wt.) | (% by wt.) | (% by wt.) | (mg) |
| Ex. 1 | TPU 1 | 98.8 | 1.0 | — | — | 23 |
| Ex. 2 | TPU 1 | 99.3 | 0.5 | — | — | 23 |
| Ex. 3 | TPU 1 | 98.3 | 1.5 | — | — | 24 |
| Ex. 4 | TPU 1 | 98.8 | 1.0 | — | — | 23 |
| Ex. 5 | TPU 1 | 93.8 | 1.0 | 5.0 | — | 23 |
| Ex. 6 | TPU 2 | 95.8 | 4.0 | — | — | 23 |
| Comp. | TPU 3 | 99.4 | 0.6 | — | — | 32 |
| Ex. 1 | | | | | | |
| Comp. | TPU 4 | 88.6 | 0.6 | — | 10 | 32 |
| Ex. 2 | | | | | | |

| | | | | Water | Water |
|---|---|---|---|---|---|
| | Bulk density | CO₂ | N₂ | pressure | temperature |
| eTPU | after 10 days | (% by | (% by | in the UWP | in the UWP |
| beads | (g/l) | wt.) | wt.) | (bar) | (° C.) |
| Ex. 1 | 168 | 1.4 | 0.21 | 9.4 | 37 |
| Ex. 2 | 175 | 1.4 | 0.21 | 9.4 | 38 |
| Ex. 3 | 169 | 1.4 | 0.21 | 9.4 | 37 |
| Ex. 4 | 160 | 1.4 | 0.21 | 9.4 | 40 |
| Ex. 5 | 160 | 1.4 | 0.21 | 9.4 | 36 |
| Ex. 6 | 117 | 1.0 | 0.21 | 9.4 | 36 |
| Comp. | 161 | 1.5 | 0.1 | 7.1 | 40 |
| Ex. 1 | | | | | |
| Comp. | 196 | 1.5 | 0.15 | 7.1 | 43 |
| Ex. 2 | | | | | |

TABLE 4
Data for the examples and comparative examples (autoclave process)

| | | | Bulk | | | | Impreg- | | | |
|---|---|---|---|---|---|---|---|---|---|---|
| | | | density | | Applied N₂ | | nation | Impreg- | | |
| | | Particle | after | Butane | pressure | Hold | temper- | nation | Expulsion | |
| | TPU | mass | 10 days | (% by | at 50° C. | time | ature | pressure | pressure | Water |
| eTPU | used | (mg) | (g/l) | wt.) | (bar) | (min) | (° C.) | (bar) | (bar) | quench |
| Ex. 7 | TPU 3 | 16 | 82 | 24 | 8 | 3 | 114 | 23.2 | 34 | yes |
| Ex. 8 | TPU 5 | 35 | 70 | 24 | 8 | 10 | 123 | 27 | 34 | no |
| Comp. | TPU 5 | 32 | 112 | 24 | 8 | 3 | 126 | 29.4 | 34 | yes |
| Ex. 3 | | | | | | | | | | |

The expanded pellets, produced by the extrusion process as well as by the tank process, were then welded in a molding machine from Kurtz ersa GmbH (Energy Foamer K68) into square slabs having a side length of 200 mm and a thickness of 20 mm by contacting with steam. The welding parameters for the various examples and comparative examples are chosen such that the surfaces of the final molding exhibit the lowest possible number of collapsed eTPU beads. In each experiment, a cooling time of 120 s was always set at the end for the fixed and the moving side of the mold. The respective steam-treatment conditions are listed in Table 5 in the form of the steam pressures and the respective steam-treatment time. The slabs obtained were heated at 70° C. for 4 h.

### Tables 5a and 5b: Steam Overpressures and Times for the Welding of the Materials of the Examples and Comparative Examples

| | | | Gap | Gap | Gap | Gap |
|---|---|---|---|---|---|---|
| | | | steaming on | steaming on | steaming on | steaming on |
| | eTPU | Gap | fixed side | fixed side | moving side | moving side |
| Component | used | (mm) | (bar) | (s) | (bar) | (s) |
| Ex. 9 | Ex. 1 | 22 | — | — | 0.4 | 18 |
| Ex. 10 | Ex. 2 | 22 | — | — | 0.5 | 15 |
| Ex. 11 | Ex. 3 | 22 | — | — | 0.75 | 18 |
| Ex. 12 | Ex. 4 | 22 | — | — | 0.5 | 15 |
| Ex. 13 | Ex. 5 | 22 | — | — | 0.2 | 18 |
| Ex. 14 | Ex. 6 | 22 | 0.8 | 20 | 0.8 | 20 |
| Ex. 15 | Ex. 7 | 10 | — | — | — | — |
| Ex. 16 | Ex. 8 | 22 | — | — | — | — |
| Comp. | Comp. | 22 | — | — | 0.9 | 18 |
| Ex. 4 | Ex. 1 | | | | | |
| Comp. | Ex. 7 | 24 | — | — | — | — |
| Ex. 5 | | | | | | |
| Comp. | Comp. | 22 | — | — | — | — |
| Ex. 6 | Ex. 3 | | | | | |
| Comp. | Comp. | 22 | — | — | — | — |
| Ex. 7 | Ex. 2 | | | | | |

| | Cross-steam | Cross-steam | Cross-steam | Cross-steam | | |
|---|---|---|---|---|---|---|
| | on fixed | on fixed | on moving | on moving | Autoclave | |
| | side/back- | side/back- | side/back- | side/back- | steam fixed/ | |
| | pressure | pressure | pressure | pressure | moving side | Autoclave |
| Component | (bar) | (s) | (bar) | (s) | (bar) | steam (s) |
| Ex. 9 | 0.4 | 10 | — | — | 0.5/0.5 | 10 |
| Ex. 10 | 0.5 | 15 | — | — | 0.5/0.5 | 10 |
| Ex. 11 | 0.8 | 15 | — | — | 0.8/0.8 | 10 |
| Ex. 12 | 0.4 | 10 | — | — | 0.4/0.4 | 10 |
| Ex. 13 | — | — | — | — | 0.4/0.4 | 10 |
| Ex. 14 | 0.9 | 20 | — | — | 0.9/0.9 | 10 |
| Ex. 15 | 0.8/0.8 | 30/20 | — | — | 0.5/0.5 | 15 |
| Ex. 16 | 1.3/1.2 | 30/25 | 1.3/1.2 | 30/25 | 1.8/1.8 | 40 |
| Comp. | 1.3 | 30 | 1.3 | 30 | 1.3/0.8 | 10 |
| Ex. 4 | | | | | | |
| Comp. | 1/0.8 | 30/20 | — | — | 0.6/0.6 | 15 |
| Ex. 5 | | | | | | |
| Comp. | 1/0.9 | 40/30 | 0.7/0.6 | 40/30 | 1.8/1.8 | 40 |
| Ex. 6 | | | | | | |
| Comp. | 0.8/0.7 | 20/25 | 0.8/0.7 | 20/25 | 1.95/1.05 | 60 |
| Ex. 7 | | | | | | |

The G modulus of the welded moldings is determined in accordance with Reference Example 1 (TPE molding). The results are summarized in Table 6.

The G modulus of individual, loose foam beads (Examples 1 to 8) was determined in accordance with Reference Example 1 (foamed pellet material) and is summarized in Table 6.

TABLE 6
G modulus (storage modulus) measured at 25° C. and 1 Hz

| | G modulus at 25° C. |
|---|---|
| Examples | [MPa] |
| Ex. 1 to 8 | <0.5 |
| Ex. 9 | 0.21 |
| Ex. 10 | 0.19 |
| Ex. 11 | 0.22 |
| Ex. 12 | 0.20 |
| Ex. 13 | 0.17 |
| Ex. 14 | 0.11 |
| Ex. 16 | 0.45 |
| Comp. Ex. 4 | 0.52 |
| Comp. Ex. 5 | 0.60 |
| Comp. Ex. 6 | 0.72 |
| Comp. Ex. 7 | 1.67 |

The comfort of seating furniture and mattresses is commonly evaluated by means of the SAG factor (determined in accordance with DIN EN ISO 2439:2009-05). The SAG factor is calculated from the ratio of the indentation hardness at an indentation depth of 65% to the indentation hardness at an indentation depth of 25% using a punch that is smaller in area than the test specimen. As a modification of the standard, the various examples and comparative examples were evaluated using a determination of compression hardness to determine a comfort factor in accordance with Reference Example 3.

The density of the molding was determined in accordance with Reference Example 2.

The compression hardness was determined in accordance with Reference Example 5.

The results of the compression hardness test for the examples and comparative examples are summarized in Tables 7 and 8. Table 7 shows the compression hardnesses from the 1st cycle and Table 8 shows the values from different cycles. The specification of the cycle is important in that the eTPU changes as a result of the first compression. As a result, the compression hardnesses measured in the next cycle are significantly lower. From no later than the 4th cycle onwards, the change is much less pronounced, which is illustrated by way of example by an example in Table 8. The measurements for the 4 cycles were performed on components produced from eTPU from Comparative Example 1.

TABLE 7
Results of the compression hardness test (1st cycle) of
the welded slabs of the examples and comparative examples

| | Density | | | | | | |
|---|---|---|---|---|---|---|---|
| | of the test | Compression | Compression | Compression | Compression | Compression | StH 65%/ |
| | specimen | hardness 10% | hardness 25% | hardness 50% | hardness 65% | hardness 75% | StH 25% |
| Name | (kg/m³) | (kPa) | (kPa) | (kPa) | (kPa) | (kPa) | (kPa/kPa) |
| Ex. 9 | 336 | 14 | 55 | 220 | 587 | 2018 | 10.7 |
| Ex. 10 | 332 | 17 | 59 | 214 | 573 | 1967 | 9.7 |
| Ex. 11 | 341 | 17 | 61 | 234 | 649 | 2423 | 10.6 |
| Ex. 12 | 323 | 15 | 55 | 207 | 540 | 1785 | 9.8 |
| Ex. 13 | 301 | 12 | 45 | 171 | 437 | 1306 | 9.7 |
| Ex. 14 | 281 | 7 | 31 | 122 | 307 | 790 | 9.9 |
| Ex. 15 | 182 | 28 | 72 | 180 | 363 | 809 | 5.0 |
| Ex. 16 | 143 | 26 | 67 | 160 | 305 | 591 | 4.5 |
| Comp. | 274 | 30 | 90 | 302 | 781 | 2438 | 8.7 |
| Ex. 4 | | | | | | | |
| Comp. | 238 | 53 | 127 | 292 | 619 | 1610 | 4.9 |
| Ex. 5 | | | | | | | |
| Comp. | 236 | 77 | 156 | 330 | 652 | 1473 | 4.2 |
| Ex. 6 | | | | | | | |
| Comp. | 369 | 167 | 415 | 1241 | 4134 | 19230 | 10.0 |
| Ex. 7 | | | | | | | |

TABLE 8
Results of the compression hardness test (for different cycles)
of the welded slabs of the examples and comparative examples

| | Test | | | | | | | |
|---|---|---|---|---|---|---|---|---|
| | specimen | | Compression | Compression | Compression | Compression | Compression | StH 65%/ |
| | density | Cycle | hardness 10% | hardness 25% | hardness 50% | hardness 65% | hardness 75% | StH 25% |
| Name | (kg/m³) | (—) | (kPa) | (kPa) | (kPa) | (kPa) | (kPa) | (kPa/kPa) |
| Ex. 15 | 182 | 4 | 17 | 56 | 152 | 325 | 772 | 5.8 |
| Comp. | 238 | 1 | 54 | 127 | 292 | 619 | 1608 | 4.9 |
| Ex. 5 | | 2 | 37 | 103 | 256 | 563 | 1542 | 5.4 |
| | | 3 | 34 | 100 | 250 | 550 | 1528 | 5.5 |
| | | 4 | 33 | 98 | 247 | 544 | 1517 | 5.6 |
| Comp. | 236 | 4 | 42 | 114 | 274 | 572 | 1410 | 5.0 |
| Ex. 6 | | | | | | | | |

The G modulus of recompacted TPU composed of expanded TPU was determined in accordance with Reference Example 6 (production of the injection molded slabs) and Reference Example 1 (determination of the G modulus (compact material)).

### 4. Examples for the Production of Hybrid Materials from Slabstock Foam (Binder) and eTPU (Examples 17 to 22)

The beads produced above were used to produce moldings using a PU foam system as binder. For this, the liquid formulation components were first compounded according to the formulation of component A (Table 10) and then mixed with component B (Table 11) in a mixing ratio of 100:104 using a laboratory stirrer (model EWTHV-05 from Vollrath GmbH) for 10 seconds. This reacting PU system was then immediately weighed out onto the beads in a ratio of 20% by weight of PU system:80% by weight of beads and mixed intensively with the aid of a laboratory stirrer in a plastic vessel made of polyethylene for 30 sec prior to being discharged into the mold. The molds used were open wooden frames treated with release agent and having internal dimensions of 20×20×1.4 cm. After smoothing the surface with Teflon film, the system was left in the mold to harden for at least 30 min. Before the test slabs were tested, they were stored at room temperature for at least 2 days in order to ensure that the PU system had reacted completely. The compression hardnesses of the test slabs obtained are listed in Table 12. The compression hardnesses and the density are determined in the same way as for the eTPU slabs.

### 5. Comparative Examples for the Production of Hybrid Materials from Slabstock Foam (Binder) and eTPU (Comparative Examples 8 to 10)

### 5.1 Comparative Example 8

Moldings were produced from Example 7 using a PU foam system. For this, the liquid formulation components were first compounded according to the formulation (Table 10) and then mixed with component B (Table 11) in a mixing ratio of 100:104 using a laboratory stirrer (model EWTHV-05 from Vollrath GmbH) for 10 sec. Component B had a residual NCO content of 18%. The residual NCO content is determined by potentiometric titration using a chlorobenzene-amine solution.

This reacting PU system was then immediately weighed out onto the beads in a ratio of 61.5% by weight of PU system:38.5% by weight of beads and mixed intensively with the aid of a laboratory stirrer in a plastic vessel made of polyethylene for 30 sec prior to being poured into the mold. The mold used was a wooden mold coated with Teflon film and having internal dimensions of 20×20×2 cm. After being filled, the mold was tightly closed with a lid. To ensure the PU foam system had hardened sufficiently, the moldings were left in the mold for 120 minutes. Before the test slabs were tested, they were stored at room temperature for at least 2 days in order to ensure that the PU system had reacted completely.

### 5.2 Comparative Example 9

Moldings were produced from Example 6 using a PU system in an analogous manner to Comparative Example 9.

### 5.3 Comparative Example 10

Moldings were produced from Comparative Example 1 using a PU system in an analogous manner to Comparative Example 9.

TABLE 9
Composition of component A

| | | OH/NH | H2O |
|---|---|---|---|
| Name | % by wt. | value | [%] |
| Polyether polyol having an OH value | 67.0 | 56.0 | 0.015 |
| of 56 and exclusively primary OH groups | | | |
| (based on tetramethylene oxide, | | | |
| functionality: 2) [parts by weight] | | | |
| Castor oil | 21.0 | 160.5 | 0.030 |
| Monoethylene glycol | 4.6 | 1810.0 | 0.200 |
| Hydroxyphenylbenzotriazole-based UV | 3.0 | 180.0 | 0.040 |
| stabilizer | | | |
| Silicone-based surfactant | 2.0 | 115.0 | 0.200 |
| 50% water and 50% fatty acid sulfonate | 2.0 | 0.0 | 50.000 |
| 1-Methylimidazole | 0.4 | 4.0 | 0.500 |

TABLE 10
Composition of component B having a residual NCO of 18%

| Name | % by wt. |
|---|---|
| Aromatic isocyanate (4,4′-methylenediphenyl diisocyanate) | 61.4 |
| [parts by weight] | |
| Carbodiimide-modified MDI | 2 |
| (4,4′MMDI[76]/CARBODIIMIDMOD. 4,4′MMDI[24]) | |
| Phenol-based primary antioxidant | 0.09 |
| Diglycol bis(chloroformate) | 0.01 |
| Polyol blend of 89.05% polypropylene glycol having a | 36.5 |
| number-average molecular weight (Mn) of 2000 g/mol | |
| (functionality = 2) and 10.95% tripropylene glycol | |

TABLE 11
Results of the compression hardness test (1st cycle) of the hybrid materials composed
of binder and eTPU for the examples and comparative examples (slab thickness 20 mm).

| | | Component | Compression | Compression | Compression | Compression | Compression | StH 65%/ |
|---|---|---|---|---|---|---|---|---|
| | eTPU | density | hardness 10% | hardness 25% | hardness 50% | hardness 65% | hardness 75% | StH 25% |
| | used | (kg/m³) | (kPa) | (kPa) | (kPa) | (kPa) | (kPa) | (kPa/kPa) |
| Ex. 17 | Ex. 2 | 235 | 16 | 39 | 129 | 350 | 1004 | 9.0 |
| Ex. 18 | Ex. 1 | 238 | 18 | 42 | 134 | 364 | 1050 | 8.7 |
| Ex. 19 | Ex. 3 | 240 | 20 | 48 | 150 | 419 | 1211 | 8.7 |
| Ex. 20 | Ex. 4 | 215 | 13 | 34 | 116 | 320 | 878 | 9.4 |
| Ex. 21 | Ex. 5 | 198 | 7 | 20 | 79 | 233 | 679 | 11.7 |
| Ex. 22 | Ex. 6 | 180 | 8 | 21 | 80 | 213 | 509 | 10.1 |
| Comp. | Ex. 7 | 351 | 114 | 208 | 517 | 1263 | 3939 | 6.1 |
| Ex. 8 | | | | | | | | |
| Comp. | Ex. 6 | 253 | 101 | 192 | 445 | 986 | 2616 | 5.1 |
| Ex. 9 | | | | | | | | |
| Comp. | Comp. | 321 | 172 | 286 | 625 | 1460 | 4319 | 5.1 |
| Ex. 10 | Ex. 1 | | | | | | | |

TABLE 12
Results of the compression hardness test (4th cycle) of the hybrid materials composed
of binder and eTPU for the examples and comparative examples (slab thickness 20 mm)

| | | Component | Compression | Compression | Compression | Compression | Compression | StH 65%/ |
|---|---|---|---|---|---|---|---|---|
| | eTPU | density | hardness 10% | hardness 25% | hardness 50% | hardness 65% | hardness 75% | StH 25% |
| | used | (kg/m³) | (kPa) | (kPa) | (kPa) | (kPa) | (kPa) | (kPa/kPa) |
| Comp. | Ex. 7 | 351 | 46 | 125 | 353 | 913 | 3436 | 7.3 |
| Ex. 8 | | | | | | | | |
| Comp. | Ex. 6 | 253 | 48 | 129 | 337 | 776 | 2311 | 6.0 |
| Ex. 9 | | | | | | | | |
| Comp. | Comp. | 321 | 60 | 156 | 398 | 1005 | 3707 | 6.4 |
| Ex. 10 | Ex. 1 | | | | | | | |

### II. Measurement Methods

### 1. Reference Example 1: Determination of the G modulus (Storage Modulus)

### 1.1 Compact Material

The G modulus of a compact thermoplastic elastomer is determined by means of a dynamic mechanical analysis (DMA) in accordance with DIN EN ISO 6721-1-7:2018-03 on test specimens, more particularly on injection molded slabs, which have previously been heated at 100° C. for 20 h, but measured from-80 to 120° C. with a 5° C. stepped heating program in a comparable manner at a continuous heating rate of 2° C./min, under torsion, at 1 Hz, and the storage modulus (G modulus) at 25° C. is determined therefrom.

### 1.2 Foamed Pellet Material

To determine the G modulus of individual, loose foam beads, these are first poured into a cylinder and compacted by repeated compression so that the highest possible packing density is achieved. Subsequently, the compression modulus, from which the storage modulus (G modulus) is calculated, is then determined under quasi-static compression.

1.3 eTPE Moldings

The G modulus of the welded examples and welded comparative examples is determined by means of a dynamic mechanical analysis (DMA) in accordance with DIN EN ISO 6721-1-7:2018-03 on the eTPE molded articles, which have previously been heated at 70° C. for 4 h, but measured from −80 to 120° C. with a 5° C. stepped heating program in a comparable manner at a continuous heating rate of 2° C./min, under torsion, at 1 Hz, and the G modulus at 25° C. determined therefrom. For the production of the test specimens employed for this purpose and having dimensions of 50×12×5 mm, an eTPU slab (200×200×10 or 20 mm) is first cut in half lengthways. The skin is then removed at the top and bottom with a splitting machine so as to obtain a sheet with a thickness of 5 mm. Care is taken to ensure that the sheet is cut out of the slab in the middle. The test specimen is then punched out of this sheet.

### 2. Reference Example 2: Determination of the Molding Density

Before the actual test, the length and width of the test specimen are determined using calipers (accuracy: ±0.01 mm, measurement in each case is made at one point in the center of the component) and the weight of the test specimen is determined using a precision balance (accuracy: ±0.001 g). The thickness of the test specimen is determined by the compression hardness testing machine using the “crosshead” displacement measurement system (accuracy: ±0.25 mm). The measured values can then be used to calculate the volume and the density.

### 3. Reference Example 3: Determination of the Comfort Factor

By analogy with the SAG factor, the comfort factor is deemed to be the ratio of the compression hardness (StH) at a compression of 65% to the compression hardness at a compression of 25%. Comparative measurements with eTPU slabs and flexible foam slabs show that the two measurement methods (SAG value determination and compression hardness test) display the same trends when comparing different materials. The absolute values of the ratios determined may differ from one another for eTPU, this being attributable to the fact that—unlike in the compression hardness determination-the measurement in the SAG factor determination is influenced by the presence or the condition of the skin on the test specimen. Since the influence of the skin on the properties can however also vary greatly depending on what the component is being used for, the compression hardness can also be used to compare different materials.

### 4. Reference Example 4: Determination of the Bulk Density

The bulk density of the bead foams is determined gravimetrically via the volume and the mass of a particle bed in a vessel (10 L). This is done by filling a funnel, which is closed at the lower outlet, with about 11 to 12 L of beads. For filling, the 10 L vessel is positioned centrally beneath the funnel. The closure of the funnel is then opened so that the beads flow evenly into the container with a defined volume (10 L). The surface of the container is leveled with a flat edge at a 45° angle. The mass is then determined gravimetrically using a balance. This must either be tared beforehand on the empty weight of the container, or the empty weight must be subtracted afterwards in order to obtain the weight of the bed. The weight divided by the volume then corresponds to the bulk density of the bead foam. Both when filling the sample vessel with beads and when transporting it to the balance, care must be taken to ensure that the vessel is not exposed to any vibration or impacts.

### 5. Reference Example 5: Determination of Compression Hardness

The test specimens used for the measurement (50 mm×50 mm×original thickness of the test slab (usually 20 mm, thickness can vary slightly depending on shrinkage, the outer skin is not removed)) are cut from a test slab (200×200×20 mm, dimensions may vary slightly depending on shrinkage) using a bandsaw. The slab is conditioned beforehand under standard climatic conditions (23±2° C. and 50±5% humidity) for 16 h. The compression hardness test likewise takes place under these climatic conditions.

Before the actual test, the length and width of the test specimen are determined using calipers (accuracy: ±0.01 mm, measurement in each case is made at one point in the center of the component) and the weight of the test specimen is determined using a precision balance (accuracy: ±0.001 g).

The compression hardness is determined using a testing machine equipped with a 50 kN force transducer (class 1 according to DIN EN ISO 7500-1:2018-06), a crosshead displacement transducer (class 1 according to DIN EN ISO 9513:2013), and two parallel unperforated pressure plates (diameter 200 mm, max. permitted force 250 kN, max. permitted surface pressure 300 N/mm²). For the determination of the density of the test specimens, the length, width, and weight are loaded into the Zwick test method. The thickness of the test specimen is determined by the universal testing machine using the “crosshead” displacement measurement system (accuracy: ±0.25 mm). The measurement itself is carried out at a testing speed of 50 mm/min and an initial force of 1 N. The stress values for compressions of 10, 25, 50, 65, and 75% are each recorded. The evaluation is based on the values for the 1st compression and also the 4th compression. The compression hardness is calculated according to equation (4). The compression hardness o is here the compressive stress in kPa determined for a deformation (e.g. 50%) during the loading process.

$$σ = ( {F}_{x} / {A}_{0} ) \times 1000 \qquad ( 4 )$$

Fₓ=Force at x % deformation [N]
A₀=Initial cross-section of the test specimen [mm²]

### 6. Reference Example 6: Determination of the G Modulus of a Compacted Foam

The test specimens for determination of the G modulus from eTPU materials are produced by injection molding. To do this, the eTPU material is removed from the component and then ground in a mill (8 mm sieve path on a Dreher S26/26 GFX-Spez-L). The eTPU pieces obtained were then dried at 110° C. for 3 h and processed into 2 mm thick test specimens in an injection molding machine at a maximum cylinder temperature of 210-215° C., die temperature of 210-220° C., and a mold temperature of 35° C. (cycle time 75 s). The test specimens thus obtained were immediately heated at 100° C. for 20 h. The storage modulus (G modulus) was then determined in accordance with Reference Example 1 (compact material).

### CITED LITERATURE

Ullmann's “Encyklopädie der technischen Chemie” [Encyclopedia of Industrial Chemistry], 4th edition, volume 20, pp. 416 ff.
WO 94/20568
WO 2007/082838 A1
WO2017/030835
WO 2013/153190 A1
WO2010/010010
“Handbook of Thermoplastic Elastomers”, 2nd edition, June 2014
“Polymer Chemistry”, Interscience Publ., New York, 1961, pp. 111-12
“Kunststoffhandbuch” [Plastics handbook], volume VIII, C. Hanser Verlag, Munich 1973
Journal of Polymer Science, Part A1, 4, pages 1851-1859 (1966)
“Kunststoffhandbuch” [Plastics Handbook], volume VII, Carl Hanser Verlag, Munich 1966 (pp. 103-113)
“Kunststoffhandbuch” [Plastics Handbook], volume 7, “Polyurethane” [Polyurethanes], Carl Hanser Verlag, 3rd edition 1993, chapter 3
“Integralschaumstoff” [Integral foam], Carl-Hanser-Verlag, Munich, Vienna, 1975
“Kunststoff-Handbuch” [Plastics handbook], volume 7, “Polyurethane” [Polyurethanes], 3rd edition, 1993, chapter 7
EP 1979401 B1
EP 3053732 A1
WO 2016/146537 A1

1. A molded article, comprising:
a foam composed of a thermoplastic elastomer (TPE-1), wherein the foam has a storage modulus (G modulus) at 25° C. and 1 Hz within a range from 0.01 to 0.5 MPa, determined by a dynamic mechanical analysis (DMA) in accordance with DIN EN ISO 6721-1-7:2018-03, and a molding density within a range from 20 to 400 kg/m³,
wherein the foam is a foamed pellet material, and
wherein the thermoplastic elastomer (TPE-1) comprises a thermoplastic polyurethane.

2. The molded article according to claim 1, wherein the thermoplastic elastomer (TPE-1) in a compact state has a G modulus at 25° C. and 1 Hz within a range from 0.8 to 8.5 MPa, determined by the dynamic mechanical analysis (DMA) in accordance with DIN EN ISO 6721-1-7:2018-03.

3. The molded article according to claim 1, wherein the molded article comprises a shell and beads of the foamed pellet material.

4. The molded article according to claim 1, wherein the foam consists of welded beads of the foamed pellet material.

5. The molded article according to claim 1, wherein the foam is a hybrid foam comprising the foamed pellet material composed of the thermoplastic elastomer (TPE-1).

6. A process for producing a molded article according to claim 1, comprising:
(i) providing a foam composed of a thermoplastic elastomer (TPE-1), wherein the foam has a storage modulus (G modulus) at 25° C. and 1 Hz within the range from 0.01 to 0.5 MPa, determined by a dynamic mechanical analysis (DMA) in accordance with DIN EN ISO 6721-1-7:2018-03, and a molding density within the range from 20 to 400 kg/m³,
wherein the foam is a foamed pellet material,
wherein the thermoplastic elastomer (TPE-1) is a thermoplastic polyurethane; and
(ii) processing the foam into a molded article.

7. The process according to claim 6, wherein the processing in (ii) takes place by welding, foaming, or bonding beads of the foamed pellet material.

8. A molded article, obtained or obtainable by the process according to claim 6.

9. The molded article according to claim 8, wherein the molded article is a shoe sole, a part of a shoe sole, a bicycle saddle, a cushioning, a mattress, a padding, a backrest, an arm pad, a pad, an underlay, a handle, a protective film, a protector, a damping element, a fall protection mat, an elastic insulating material, a sealing material or a component in an automotive interior and exterior sector.

10. A method, comprising:
producing an article with the molded article according to claim 1,
wherein the article is a floor, a mattress, a seating furniture, a bicycle saddle, a car seat, a motorcycle seat, a component of a shoe, a shoe insert, a packaging, a shock absorber, a protector, a fall protection mat, an elastic insulating material, or a sealing material.

11. The molded article according to claim 1, wherein the thermoplastic elastomer (TPE-1) consists of thermoplastic polyetheramide.
